(19) United States
(12) Patent Application Publication
(10) Pub. No.: US 2021/0387198 A1
(43) Pub. Date: Dec. 16, 2021

(54) EASY-DISCONNECT SEAL MATCHING RESERVOIR AND HOLDER PLATFORM FOR MICROFLUIDIC CHIP

(71) Applicant: IVD R.E.D. Microfluidic Chip Service & Support Corporation, Hsinchu County (TW)

(72) Inventor: Ya-Lin Huang, Hsinchu County (TW)

(21) Appl. No.: 17/342,867

(22) Filed: Jun. 9, 2021

(30) Foreign Application Priority Data
Jun. 11, 2020 (TW) 109119604

(51) Int. Cl. B01L 3/00; B01L 9/00

(52) U.S. Cl. CPC B01L 3/563; B01L 2200/0689; B01L 2200/027; B01L 9/527

(57) ABSTRACT

An easy-disconnect seal matching reservoir for connecting the microfluidic chip and the pipette. The reservoir comprises at least one first coupling unit and at least one second coupling unit. The first coupling unit includes a first end and a second end opposed to the first end, and the first end is disposed on an inlet of the microfluidic chip. The second coupling unit includes a third end and a fourth end opposed to the third end, and a pipe connected between the third end and the fourth end. The third end is coupled to the second end of the first coupling unit. The pipette can be put in the pipe via the fourth end.

### CROSS REFERENCE TO RELATED APPLICATIONS

This present application claims the benefits of Taiwan Patent Application No. 109119604, filed on Jun. 11, 2020.

### FIELD OF THE INVENTION

The present invention relates to the design of a convenient reservoir for microfluidic chip, which the liquid is injected into by the reservoir. More particularly, the present invention relates to an easy-disconnect seal matching reservoir and holder platform for microfluidic chip with easy liquid injection.

### BACKGROUND OF THE INVENTION

People's requirements for health care are increasing day by day, and the traditional medical technology can no longer meet the needs. The main reason is that the existing medical equipment is basically still based on traditional large-scale machines. The equipment is bulky and expensive, and it is not easy to carry or move. Professional technicians are required for operation, and plenty of reagents and samples are also required for testing.

In order to respond to the above-mentioned needs, the existing micro-electro-mechanical system (MEMS) technology is used to develop the biological micro-electro-mechanical system (Bio-MEMS). The entire detection system is miniaturized and combined on a single chip to become a so-called laboratory chip (lab on a chip). The laboratory chip can be combined with microfluidic systems, so that medical testing can be completed on this microfluidic chip, and it has the advantages of high efficiency, low reagent consumption and rapid detection.

### SUMMARY OF THE PRESENT INVENTION

The present invention provides an easy-disconnect seal matching reservoir and holder platform for microfluidic chip. It is helpful for hospital technicians or researchers to conveniently and intuitively operate the fluids such as the tester's blood, reagents or buffer solutions, and to inject them into the microfluidic chip for metering, mixing, washing, separation, reaction, or testing.

According to one embodiment of the present invention, a reservoir is provided for connecting a microfluidic chip and a pipette. The microfluidic chip provides at least one inlet. The reservoir includes at least one first coupling unit having a first end and a second end opposed to the first end; and at least one second coupling unit having a third end and a fourth end opposed to the third end, and a pipe connected between the third end and the fourth end. The third end of the second coupling unit is coupled to the second end of the first coupling unit. The first end of the first coupling unit is for being disposed on the inlet; and the fourth end of the second coupling unit is for the pipette putting in the pipe through.

In one embodiment, the first coupling unit is provided by an upper plate, and the upper plate is disposed on the microfluidic chip.

In one embodiment, the second end of the first coupling unit is a protrude ring. The third end of the second coupling unit is a groove of circle, and the protrude ring is accommodated by the groove of circle for connection.

In one embodiment, the pipe of the second coupling unit is a truncated cone, and the pipe has a nozzle and a wide end opposed to the nozzle. The nozzle is connected to the third end. The pipette is putted in the pipe through the wide end.

In one embodiment, the pipette includes a micropipette or a dropper, and the pipette can be a plastic pipette, a glass pipette, or the micropipette or the dropper made of other materials. A micro liquid container is formed when the reservoir is connected to the micropipette, and the micropipette can be a disposable micropipette.

In one embodiment, the microfluidic chip comprises an upper plate, a microfluidic channel structure and at least one filter. The microfluidic channel structure includes an array of a plurality of micro-pores. Each of the micro-pores is a flip-funnel with a narrow inlet and a wide outlet, and the diameter of the narrow inlet is a little larger than the size of cell. Thus, the resistance of the cells to flow is increased if the cell goes into the narrow inlet one by one, and the cells are passively arranged in the fluid so that the cell screening is resulted by each of micro-pores.

In one embodiment, the filter includes a filter paper. The filter paper is attached to the bottom of the array of the micro-pores. The waste of the fluids is extracted and the cell is kept on the filter paper.

According to one embodiment of the present invention, a holder platform is provided for holding the microfluidic chip and the reservoir, and it's helpful for hospital technicians or researchers to conveniently and intuitively operate the fluids and to inject the fluids into the microfluidic chip for testing. The holder platform includes a lid and a base for the microfluidic chip and then the reservoir placed.

In one embodiment, the base includes a plurality of filter pores and a container under the filter pores. The lid and the base are pressed together by an o-ring.

### BRIEF DESCRIPTION OF THE DRAWINGS

FIG. 1A presents the schematic diagrams of a reservoir for a microfluidic chip according to the embodiments of the present invention.

FIG. 1B and FIG. 1C, FIG. 1D and FIG. 1E, and FIG. 1F and FIG. 1G respectively present, three designs of second coupling units of the reservoir with different lengths and their cross-section views.

FIG. 2A and FIG. 2B respectively present, a schematic diagrams of a microfluidic chip and its exploded view according to one embodiment of the present invention.

FIG. 3A and FIG. 3B present the joint steps when the first coupling units are coupled to the two groups of the second coupling units of a reservoir according to the embodiments of the present invention.

FIG. 4 presents a reservoir for connecting a microfluidic chip and a pipette according to one embodiment of the present invention.

FIG. 5A and FIG. 5B present a schematic diagrams of a microfluidic chip and its exploded view respectively, according to another embodiment of the present invention.

FIG. 5C presents an enlargement diagram of the microfluidic channel structure of the microfluidic chip in FIG. 5A.

FIG. 6 presents a schematic diagrams of a simple holder platform for the reservoirs and a microfluidic chip in the operation.

FIG. 7A and FIG. 7B present the operation steps of another holder platform according to one embodiment of the present invention.

FIG. 7C present the holder platform for holding a microfluidic chip, the reservoirs and the pipettes.

### DETAILED DESCRIPTION OF THE INVENTION

It is to be understood that both the foregoing general description and the following detailed description are exemplary and explanatory only and are not restrictive of the invention, as claimed. It should be noted that, as used in the specification and the appended claims, the singular forms “a”, “an” and “the” include plural referents unless the context clearly dictates otherwise. The use of the terms “contain”, “contains”, “containing”, “include”, “includes”, “including,” “have,” “has,” or “having” should be generally understood as open-ended and non-limiting unless specifically stated otherwise. The use of the direction terms “top”, “bottom”, “on”, “under”, “up”, “down”, “left, “right”, “front” or “rear”, etc. is only reference to the drawings. Thus, the direction is not limited in the present invention.

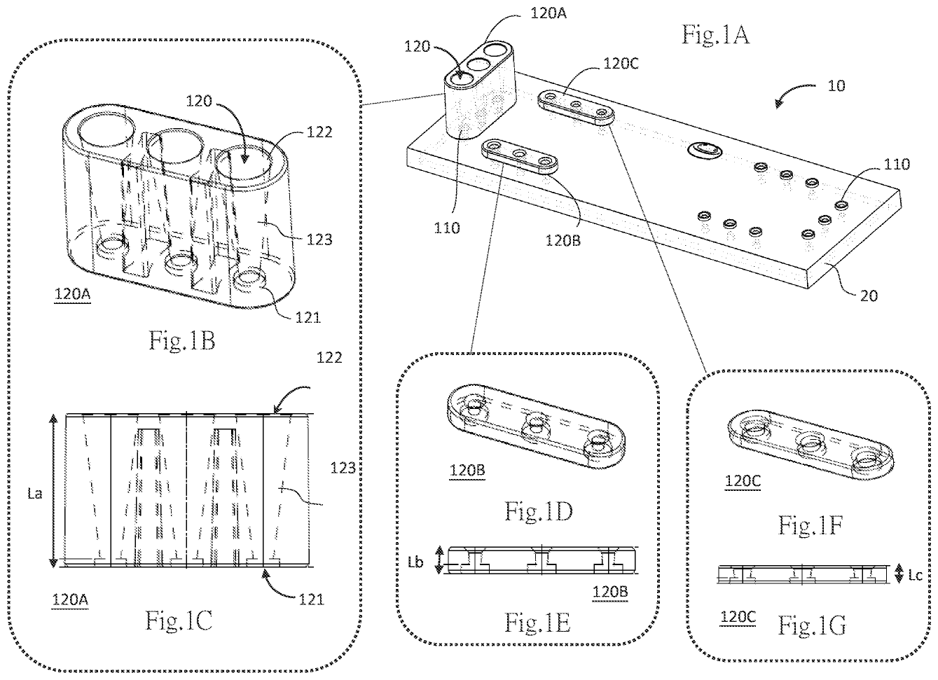

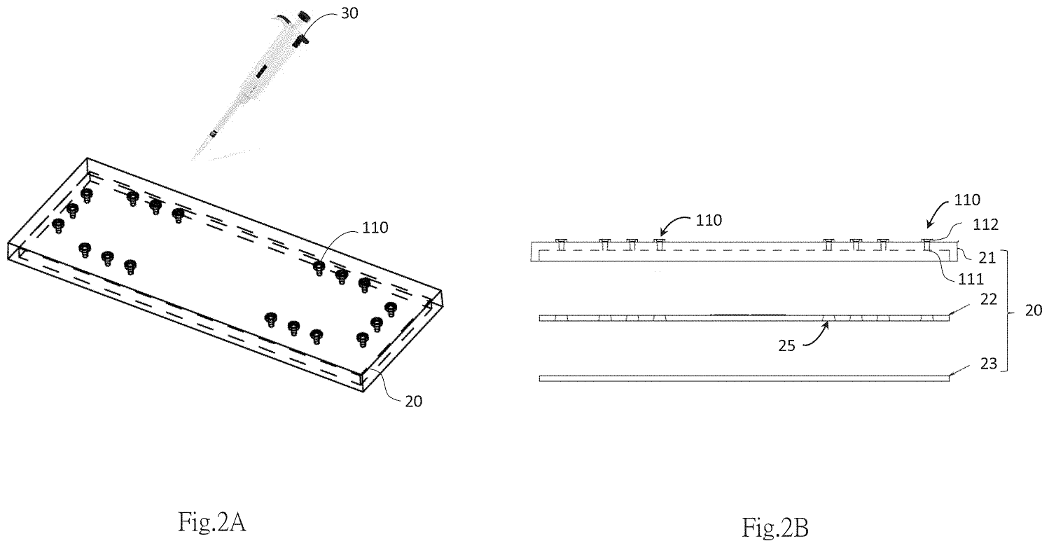

FIG. 1A shows the schematic diagram of a reservoir 10 for a microfluidic chip 20 according to the embodiments of the present invention. FIG. 1B and FIG. 1C, FIG. 1D and FIG. 1E, and FIG. 1F and FIG. 1G respectively present, three designs of the second coupling units with different lengths and their cross-section views. FIG. 2A and FIG. 2B respectively show a schematic diagrams of a microfluidic chip 20 and its exploded view. The microfluidic chip 20 is connected to a pipette 30 by the reservoir 10. The microfluidic chip 20 provides at least one inlet 25, and includes an upper plate 21, a microfluidic channel structure 22 and a body 23. A plurality of inlets 25 are disposed on the microfluidic channel structure 22. The upper plate 21 and the body 23 can be the rectangular plastic sheets.

The reservoir 10 includes at least one first coupling unit 110 and at least one second coupling unit 120, having different designs of the groups 120A, 120B or 120C. The first coupling unit 110 having a first end 111 and a second end 112 opposed to the first end. The first end 111 is for being disposed on the inlet 25. In one embodiment of the present invention, the first coupling unit 110 is provided by the upper plate 21 and the upper plate 21 is disposed on the microfluidic chip 20, so that the first end 111 of the first coupling unit 110 is disposed corresponding to the inlet 25 of the microfluidic chip 20 one by one. In a preferred embodiment, the second end 112 of the first coupling unit 110 is a protrude ring. Thus, the hospital technicians or researchers can conveniently operate the pipette 30 to inject the fluid into the microfluidic chip 20 by leaning against the protrude ring 110.

FIG. 1B, FIG. 1D and FIG. 1F show three different designs of the groups 120A, 120B and 120C of the second coupling units 120 of the reservoir 10. Each design is three second coupling units 120 as a group. The difference between the three groups is mainly in length, that is, the length of the pipes of the three groups is different. With several lengths of the groups 120A, 120B and 120C of the second coupling units 120, the hospital technicians or researchers can easily use different pipette 30 to match. As shown in FIG. 1C, FIG. 1E and FIG. 1G, the length of the group 120A of the second coupling unit is La, the length of the group 120B of the second coupling unit is Lb, and the length of the group 120C of the second coupling unit is Lc. The relationship of the lengths of the groups 120A, 120B and 120C is La>Lb>Lc. It should be noted that, the design with three second coupling units 120 as a group is not limited in the present invention. The number of the second coupling units 120 as a group can be two, five or six, etc.

For brevity, only the second coupling units 120 of the groups 120A is described in detail as following. The second coupling unit 120 has a third end 121 and a fourth end 122 opposed to the third end 121, and a pipe 123 connected between the third end 121 and the fourth end 122. The third end 121 of the second coupling unit 120 is coupled to the second end 112 of the first coupling unit. 110. The fourth end 122 of the second coupling unit 120 is for the pipette 30 putted in the pipe 123 through. The design of the second coupling unit 120 is for the hospital technicians or researchers to conveniently and intuitively put the pipette 30 in the pipe 123. In this way, because of the design cooperation between the first coupling unit 110 and the group 120A, 120B or 120C of the second coupling units of the reservoir 10, the hospital technicians or researchers can not keep the pipette 30 on the microfluidic chip 20 by hand; and instead, they can lean the pipette 30 in the reservoir 10 to easily connect with the microfluidic chip 20.

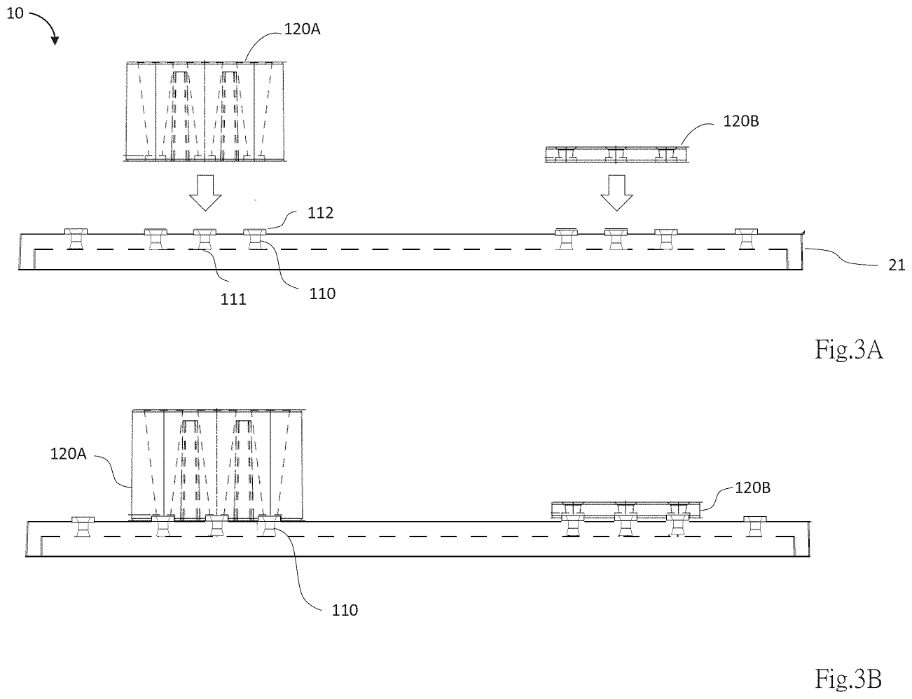

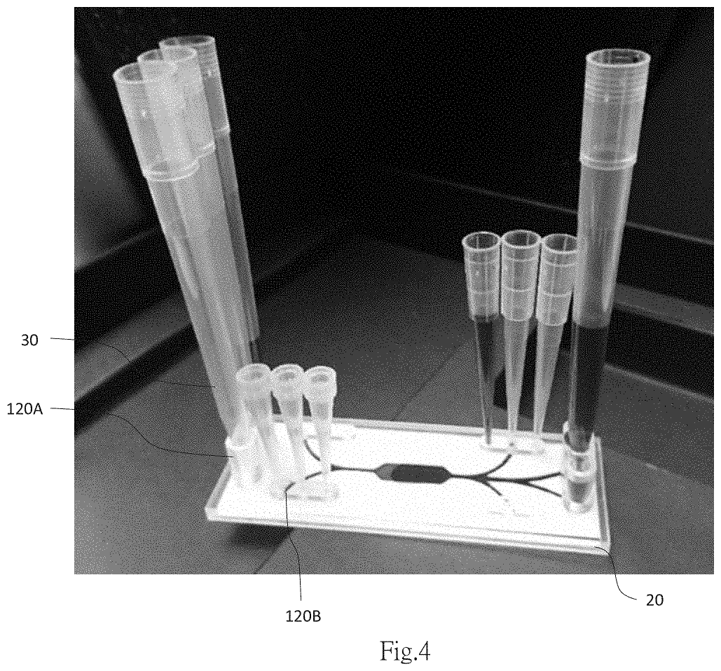

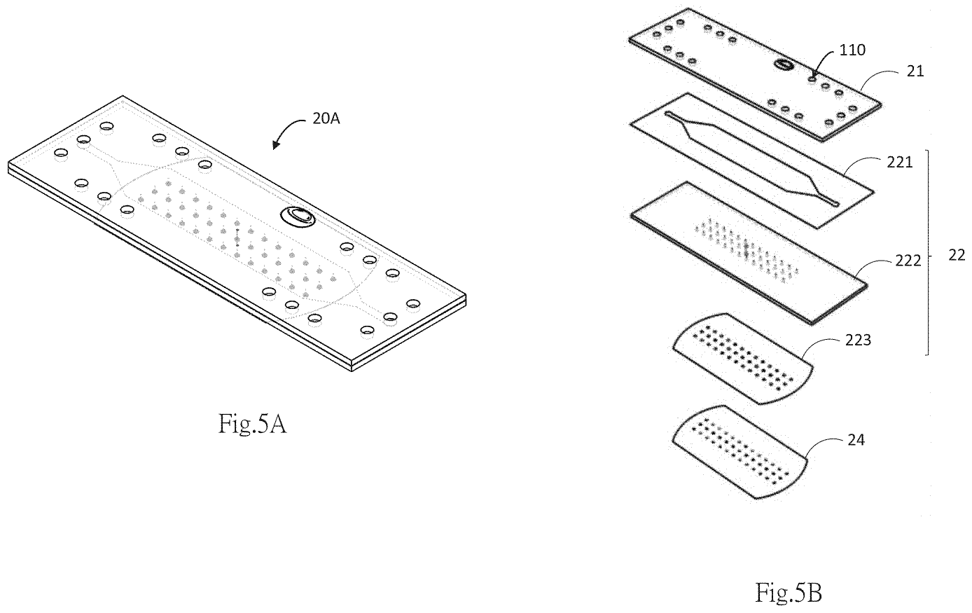

FIG. 3A and FIG. 3B present the joint steps when the first coupling units 110 are coupled to the two groups 120A and 120B of the second coupling units of a reservoir 10 according to the embodiments of the present invention. The first coupling units 110 are disposed on the upper plate 21, and the two groups 120A and 120B of the second coupling units of the reservoir 10 are easily connected with the upper plate 21 by the first coupling units 110. Please refer to FIG. 1AA, the third end 121 of the second coupling unit 120 is a groove of circle, and the protrude ring 112 is accommodated by the groove of circle 121 for connection. In one embodiment, the pipe 123 of the second coupling unit 120 is a truncated cone, and the pipe 123 has a nozzle (not labelled) and a wide end 122 opposed to the nozzle. The nozzle is connected to the third end 121. Therefore, the pipette 30 is easy for putted in the pipe 120 through the wide end 122.

FIG. 4 presents a reservoir for connecting a microfluidic chip and a pipette according to one embodiment of the present invention. In order to supply long-term and large-volume fluids input, the microfluidic chip 20 can be connected to the different sizes of the pipette 30 by the different designs of the reservoirs 10 (with the groups 120A, 120B and 120C of the of the second coupling units), and the fluids flow slowly through gravity. In one embodiment, the pipette 30 includes a micropipette or a dropper, and the pipette can be a plastic pipette, a glass pipette, or the micropipette or the dropper made of other materials. A micro liquid container is formed when the reservoir 10 is connected to the micropipette 30, and the micropipette can be a disposable micropipette.

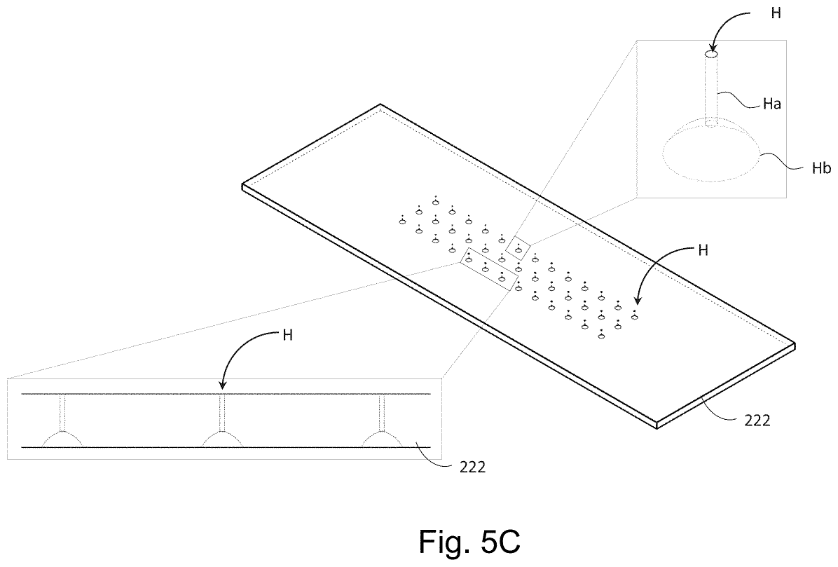

FIG. 5A and FIG. 5B present a schematic diagrams of a microfluidic chip and its exploded view respectively, according to another embodiment of the present invention. The modified microfluidic chip 20A is used instead of the microfluidic chip 20 in the previous embodiments. The modified microfluidic chip 20A is a novel passive microfluidic cell isolation chip with micro-machined micro-pore array, for single cell isolation of BeWo (or called ATCC CCL-98), which is human placental choriocarcinoma cell. Currently, several tools, such as flow cytometry, serial dilution, manual cell picking, and cell printer, are applied for cell isolation and analysis. In order to simplify the sample preparation, culture, and analysis, reagents and professionals such as hospital technicians or researchers are only required for the procedure by using the reservoir 10 and the modified microfluidic chip 20A of the present invention.

The microfluidic chip 20A comprises an upper plate 21, a microfluidic channel structure 22 and at least one filter 24. The first coupling unit 110 of the reservoir 10 is disposed on the upper plate 21. The microfluidic channel structure 22 includes an array of a plurality of micro-pores 222, a pictured layer 221 for attaching the upper plate 21 to the micro-pores array 222, and a micro-pore layer 223 for attaching the micro-pores array 222 to the filter 24.

FIG. 5C presents an enlargement diagram of the array of the micro-pores 222 in the microfluidic channel structure of the microfluidic chip 20A in FIG. 5A. In a preferred embodiment, cyclic olefin copolymer (COC) has the biocompatiblility with cells and is used for the upper plate 21 and the microfluidic channel structure 22 as the material. The array of the micro-pores 222, such as 50 μm of the micro-pores, is made by using laser micro-machining technology on plastic substrate. In one embodiment, the filter 24 in FIG. 5B includes a filter paper. The filter paper 24 is attached to the bottom of the array of the micro-pores 222. The waste of the fluids is extracted and the cell is kept on the filter paper. For example, the filter 24, such as 5 μm of the filter paper is attached to the bottom of the microfluidic chip 20A, and the cell flows to the filter 24 via the array of the micro-pores 222 of the microfluidic chip 20A, for cell cultivation. Each H of the micro-pores 222 is a flip-funnel with a narrow inlet Ha and a wide outlet Hb, and the diameter of the narrow inlet is a little larger than the size of cell. Thus, the resistance of the cells to flow is increased if the cell goes into the narrow inlet Ha one by one, and the cells are passively arranged in the fluid so that the cell screening is resulted by each H of micro-pores.

The microfluidic chip 20 or 20A as described in the previous embodiments can be injected the fluid via the connection of the reservoir 10 by manual dropping or holding the pipette 30 on by hand. Moreover, it provides more pressure and faster speed when fluid is injected into the microfluidic chip 20 or 20A, especially is hold on a holder platform.

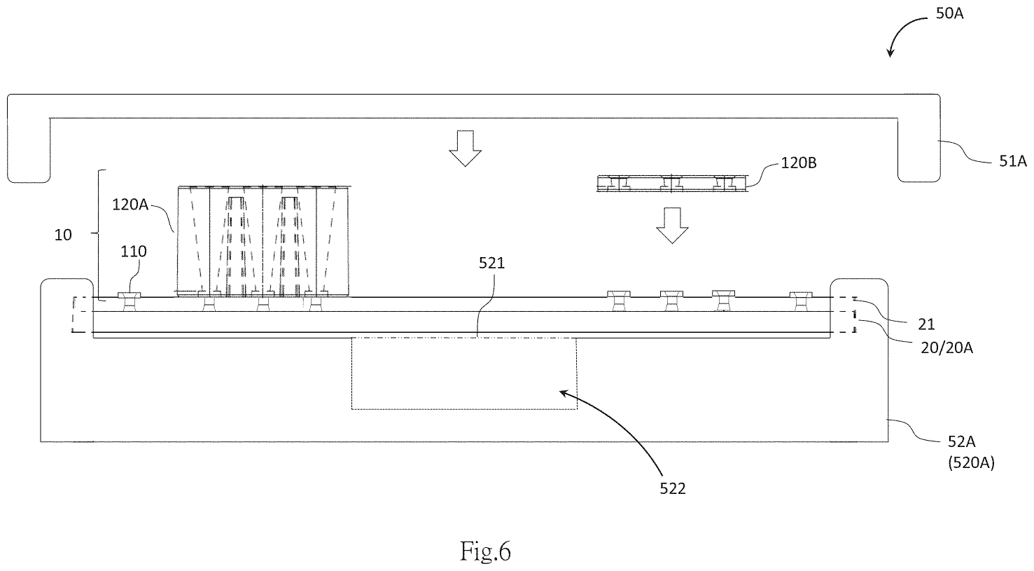

FIG. 6 presents a schematic diagrams of a simple holder platform 50A for the reservoirs 10 and a microfluidic chip 20 in the operation. The holder platform 50A is a simple and convenient portable platform, and is provided for holding the microfluidic chip 20/20A and the reservoir 10. It's helpful for hospital technicians or researchers to conveniently and intuitively operate the fluids such regents, buffer liquid . . . etc., and to inject/discharge the fluids into/out from the microfluidic chip for metering, mixing, washing, separation, reaction, or testing.

The holder platform 50A includes a lid 51A and a case 52A. The case 52A has a base 520A for the microfluidic chip 20/20A and then the reservoir 10 placed. An o-ring is disposed between the lid 51A and the base 520A, so the operator can easily pressed the lid 51A and the base 520A together along the arrow as shown in FIG. 6. The base 520A includes a plurality of filter pores 521 and a container 522 under the filter pores 521. In one embodiment, the filter pores 521 are arranged radially with concentric circles. The container 522 is used for receiving the waste of the fluids. For example, the waste of the fluids is extracted from the filter paper 24 and flow to the container 522 via the filter pores 521.

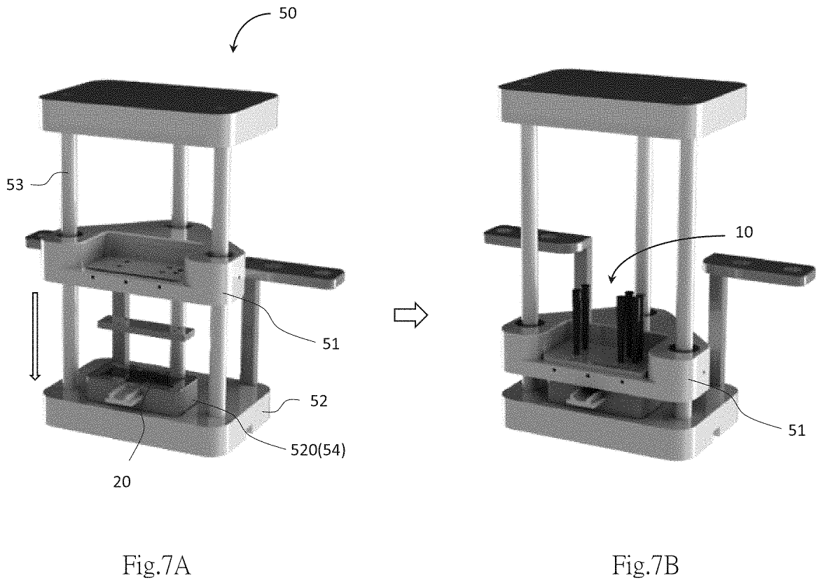

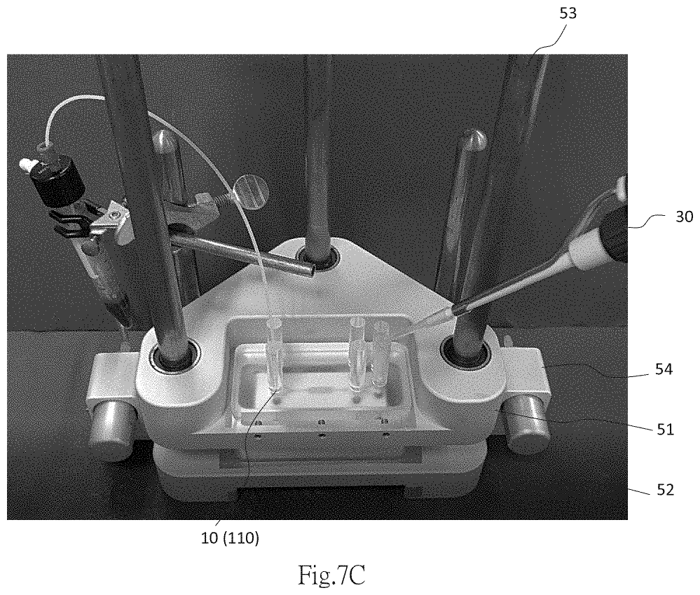

FIG. 7A and FIG. 7B present the operation steps of another holder platform 50 according to one embodiment of the present invention. Compared with the holder platform 50A, the holder platform 50 has a multi-functional characteristic. The holder platform 50 includes an upper sheet 51 for the reservoir 10 placed, a lower sheer 52 having a base 520 for the microfluidic chip 20/20A placed, a moving module 53 for driving the upper sheet 51 to move up and down along a vertical direction as the arrow shown in FIG. 7A. As shown in FIG. 7A and FIG. 7B, the upper sheet 51 and the lower sheet 52 can be pressed together by the moving module 53, so the reservoir 10 can be connected to the microfluidic chip 20. The holder platform 50 further includes a driving module 54 disposed on the base 520. The driving module 54 can be a manual pump or a motive pump. There is further a magnet disposed on the base 520, for driving the fluids in the microfluidic chip by the magnetic force.

FIG. 7C present the holder platform 50 for holding a microfluidic chip 20/20A, the reservoirs 10 and the pipettes 30. Because of the designed platform of the upper sheet 51, the lower sheet 52 and the moving module 53, the microfluidic chip 20 can easily be placed on the base of the lower sheet 52, for connecting to the reservoir 10 on the upper sheet 551 corresponding to the inlet of the microfluidic chip 20. By utilizing the close contact between the reservoir 10 and the microfluidic chip 20 via the o-ring, the fluid can be driven between them. Also, the design of the reservoir 10 is facilitated for injection. The holder platform 50 is helpful for hospital technicians or researchers to conveniently and intuitively operate the fluids such regents, buffer liquid . . . etc., and to inject/discharge the fluids into/out from the microfluidic chip 20 for testing or biochemical reaction.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A reservoir for connecting a microfluidic chip and a pipette, wherein the microfluidic chip provides at least one inlet, the reservoir comprising:
at least one first coupling unit, having a first end and a second end opposed to the first end; and
at least one second coupling unit, having a third end and a fourth end opposed to the third end, and a pipe connected between the third end and the fourth end;
wherein the third end of the second coupling unit is coupled to the second end of the first coupling unit;
the first end of the first coupling unit is for being disposed on the inlet; and
the fourth end of the second coupling unit is for the pipette putted in the pipe through.

2. The reservoir of claim 1, wherein the first coupling unit is provided by an upper plate, and the upper plate is disposed on the microfluidic chip.

3. The reservoir of claim 1, wherein the second end of the first coupling unit is a protrude ring.

4. The reservoir of claim 3, wherein the third end of the second coupling unit is a groove of circle, and the protrude ring is accommodated by the groove of circle for connection.

5. The reservoir of claim 1, wherein the pipe of the second coupling unit is a truncated cone, and the pipe has a nozzle and a wide end opposed to the nozzle, the nozzle is connected to the third end, the pipette is for putted in the pipe through the wide end.

6. The reservoir of claim 1, wherein the pipette includes a micropipette, and a micro liquid container is formed when the reservoir is connected to the micropipette.

7. The reservoir of claim 1, wherein the microfluidic chip comprises an upper plate, a microfluidic channel structure and at least one filter.

8. The reservoir of claim 7, wherein the microfluidic channel structure includes an array of a plurality of micro-pores, each of the micro-pores is a flip-funnel with a narrow inlet and a wide outlet, and the diameter of the narrow inlet is a little larger than the size of cell.

9. The reservoir of claim 8, wherein the at least one filter includes a filter paper, the filter paper is attached to the bottom of the array of the micro-pores, and the cell is kept on the filter paper.

10. The reservoir of claim 1, further comprising a holder platform, and the holder platform comprising:
a lid; and
a base, for placing the microfluidic chip and then the reservoir.

11. The reservoir of claim 10, wherein the base includes a plurality of filter pores and a container under the filter pores.

12. The reservoir of claim 10, wherein the lid and the base are pressed together by an o-ring.
